(19) United States
(12) Patent Application Publication
(10) Pub. No.: US 2023/0048293 A1
(43) Pub. Date: Feb. 16, 2023

(54) PROVIDENCE CERTIFICATION

(71) Applicant: Emoji ID, LLC, Oakland, CA (US)

(72) Inventor: Cayle Jon Sharrock, Lisbon (PT)

(21) Appl. No.: 17/390,755

(22) Filed: Jul. 30, 2021

(51) Int. Cl. G06Q 30/00; H04L 9/32

(52) U.S. Cl. CPC G06Q 30/018; H04L 9/3263; H04L 9/3247; H04L 9/3252

(57) ABSTRACT

Implementations generally relate to providence certificates. In some implementations, a method includes generating a first providence certificate digitally signed with a first private encryption key, where the first providence certificate is associated with a first component of a product, and where the first providence certificate provides a first predetermined assurance. The method further includes generating a second providence certificate digitally signed with a second private encryption key, where the second providence certificate is associated with the product, and where the second providence certificate provides the first providence certificate and a second predetermined assurance.

### SUMMARY

Implementations generally relate to providence certificates. In some implementations, a method includes generating a first providence certificate digitally signed with a first private encryption key, where the first providence certificate is associated with a first component of a product, and where the first providence certificate provides a first predetermined assurance. The method further includes generating a second providence certificate digitally signed with a second private encryption key, where the second providence certificate is associated with the product, and where the second providence certificate provides the first providence certificate and a second predetermined assurance.

### BRIEF DESCRIPTION OF THE DRAWINGS

FIG. 1 is a block diagram of an example environment for providing providence certification in a supply chain, which may be used for implementations described herein.

FIG. 2 is a block diagram of an example network environment for providing providence certification, which may be used for implementations described herein.

FIG. 3 is an example flow diagram for providing providence certification, according to some implementations.

FIG. 4 is a block diagram of an example network environment, which may be used for some implementations described herein.

FIG. 5 is a block diagram of an example computer system, which may be used for implementations described herein.

### DETAILED DESCRIPTION

Implementations described herein provide providence certificates. As described in more detail below, a system generates providence certificates in a supply chain and generates a final providence certificate at the end of the supply chain. These providence certificates provide assurances about various aspects of a product. As a result, providence certificates indicate trustworthiness to sources in the supply chain, the final source in the supply chain, and the ultimately the end user.

In some implementations, the system generates first stage providence certificates, which each is digitally signed with a private encryption key. The first stage may represent an upstream portion of a supply chain. The first stage providence certificates are associated with various components of a product and provide various predetermined assurance such has how particular components of the product were made, their qualities, purity, safety, etc. The system also generates a final providence certificate that is digitally signed with a private encryption key. The second providence certificate is associated with the product. The second providence certificate also provides the first providence certificate and a final predetermined assurance. In some implementations, the final predetermined assurance ensures all assurances are met in association with the product.

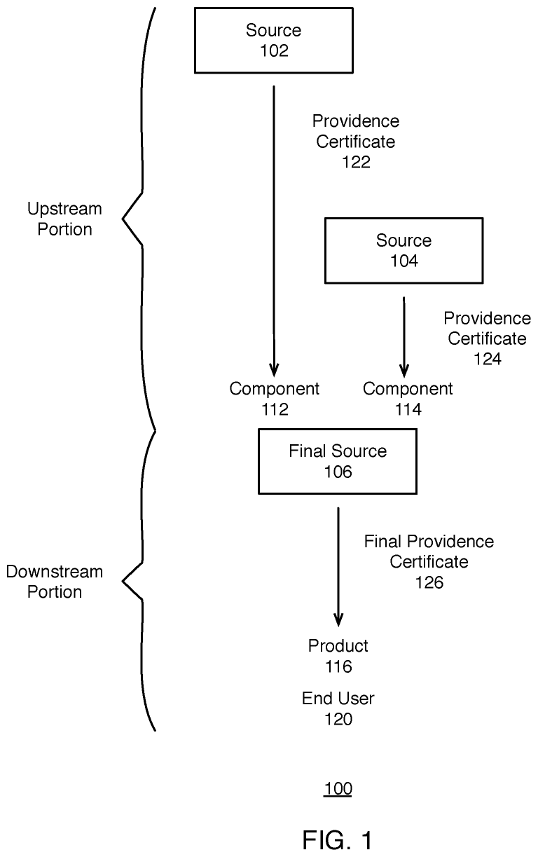

FIG. 1 is a block diagram of an example environment 100 for providing providence certification in a supply chain, which may be used for some implementations described herein. The following description provides an example context for various implementations described herein. As shown, various sources such as source 102, a source 104, and final source 106 constitute a supply chain having an upstream portion and a downstream portion. The upstream portion of the supply chain may include suppliers of various components 112 and 114 of a product 116. Source 102 and source 104 may represent such suppliers in the upstream portion of the supply chain.

For ease of illustration, two upstream sources are shown. The number of sources for a given product may vary, depending on the particular implementation. Also shown are two sources 102 and 104 that provide components 112 and 114 directly to final source 106. In some implementations, a given upstream source may provide a product or incomplete product to another upstream source, where a given product may pass from one source to another in serial until the product reaches a final source. The particular configuration of the sources in the upstream and/or downstream may vary, and depend on the particular implementation.

The downstream portion of the supply chain may include a final supplier or seller of the product to the end user. Final source 106 may represent the final supplier. The particular number of sources in each of the upstream portion and the downstream portions may vary from product to product, and will depend on the particular implementation.

In an example implementation, source 102 may be a glass producer that provides a component 112 (e.g., a glass bottle) of product 116. Component 112 in this example would be a glass bottle, and product 116 is a bottle of Champagne.

In this example, source 102 sends component 112 or glass bottle to final source 106, which may add components to product 116. In this example, final source 106 would add Champagne produced by source 106 to the glass bottle provided by source 102. Alternatively, in final source 106 may receive the Champagne from yet another source (not shown) to add to the glass bottle. Final source 106 may be referred to as a final source in that it is the final source of the product to the end user.

In the same example, source 104 may be a cork producer that provides a component 114 of product 116. Component 114 in this example would be a cork, and wherein product 116 is a bottle of Champagne as indicated above. In this example, source 104 sends component 114 (e.g., a cork) to final source 106.

For ease of illustration, components 112 and 114 are described in the context of a single glass bottle and a single cork. The number of types of components and the number of each type of component may vary, depending on the particular implementation.

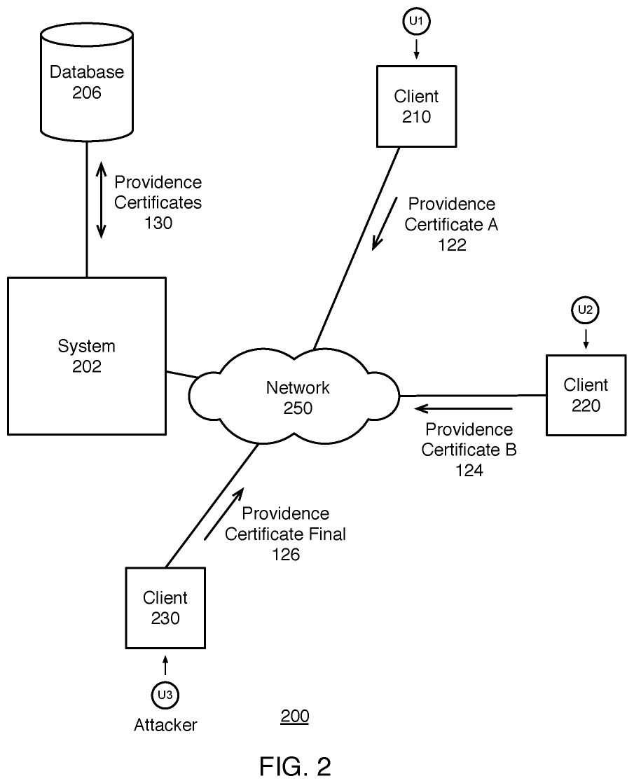

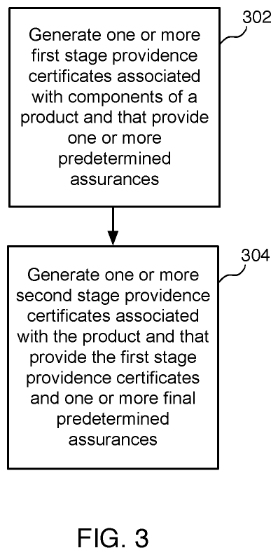

As indicated above, final source 106 adds Champagne to the glass bottle provided by source 102. In some implementations, final source 106 may produce and provide the Champagne. Alternatively, in some implementations, final source 106 may receive the Champagne from an upstream source before bottling the Champagne. Final source 106 seals the glass bottle of Champagne with a cork produced by source 104. Final source 106 may then sell product 116 as a final or complete product to end user 120. Further example implementations directed to the sources are described in more detail herein in connection with FIGS. 2 and 3, for example.

As described in more detail herein, the system generates providence certificates for component of product 108 including a final providence certificate for final product 108. In various implementations, the system enables each providence certificate to be digitally signed by each source of respective components of product 116. Each certificate is digitally signed and accompanies product 116 to its next destination.

Source 102 for example may provide a digitally signed providence certificate 122 that ensures that component 112 or the glass bottle provided by source 102 is made from material that meets one or more predetermined criteria (e.g., ethically sourced glass, etc.). In another example, source 104 may provide a digitally signed providence certificate 124 that ensures that component 114 or the cork provided by source 104 is made from material that meets a predetermined criteria (e.g., made from particular sustainable materials, etc.).

Final source 106 may provide a digitally signed final providence certificate 126 that includes the associated providence certificates from upstream sources such as providence certificates 122 and 124. Final providence certificate 126 may also include additional assurances. For example, in some scenarios, final source 106 may add components and the final providence certificate 126 may ensure that the added components meet predetermined requirements. As a result, final providence certificate gives end user an assurance of product 116 meeting these requirements. Further example implementations directed to the providence certificates are described in more detail herein in connection with FIGS. 2 and 3, for example.

FIG. 2 is a block diagram of an example network environment 200 for providing providence certification, which may be used for implementations described herein. In some implementations, network environment 200 includes a system 202, which accesses a database 206. Network environment 200 also includes client devices 210, 220, and 230, which may communicate with system 202 and/or may communicate with each other directly or via system 202. Network environment 200 also includes a network 250 through which system 202 and client devices 210, 220, and 230 communicate. Network 250 may be any suitable communication network such as a Wi-Fi network, Bluetooth network, the Internet, etc.

In the example scenario of FIG. 2, clients 210, 220, and 230 may be associated with respective sources 102, 104, and 106 of FIG. 1. For example, source 102 may be a glass producer, source 104 may be cork producer, and source 106 may be a Champagne producer.

In various implementations, system 202 enables clients 210, 220, and 230 associated with respective sources to provide digitally signed providence certificates 122, 124, and 126 to system 202, which may store to and later fetch providence certificates 130 in general, including providence certificates 122, 124, and 126 from database 206. In various implementations, the final providence certificate ensures all assurances are met in association with the final product.

For ease of illustration, FIG. 2 shows one block for each of system 202, database 206, and shows three blocks for client devices 210, 220, and 230. Blocks 202 and 206 may represent multiple systems and network databases. Also, there may be any number of client devices. In other implementations, environment 200 may not have all of the components shown and/or may have other elements including other types of elements instead of, or in addition to, those shown herein.

While system 202 performs implementations described herein, in other implementations, any suitable component or combination of components associated with system 102 or any suitable processor or processors or networks including blockchain networks associated with system 102 may facilitate performing the implementations described herein.

In various implementations, system 202 includes a blockchain network (not shown) having nodes, where each node maintains respective copies of a blockchain. The blockchain network may include hundreds or thousands of nodes. Also, the blockchain network may be a distributed peer-to-peer network. In some implementations, the blockchain network may implement known consensus algorithms to validate transactions submitted to the blockchain network. A verified transaction may include transferred cryptocurrency, contracts, records, or other information to be recorded to the blockchain. In some embodiments, multiple transactions are combined together into a block of data that is verified across blockchain network. Once verified, this block of data can be added to an existing blockchain.

In various implementations, the blockchain includes a distributed ledger that maintains emoji identifications (IDs). As described in more detail herein, an emoji ID includes a sequence of emojis utilized to provide a user with an easy and intuitive way to identify a person or entity such as a company. In various implementations, the blockchain of the system may verify an emoji ID by checking the emoji ID against the base node of the blockchain to determine the authenticity or validity of the emoji ID. Further implementations directed to emoji IDs are described in more detail herein.

In various implementations, emoji IDs may be associated with public and private keys. Public and private keys are an integral component of cryptocurrencies and other digital assets such as non-fungible token (NFTs) built on blockchain networks and are part of a larger field of cryptography known as public-key cryptography (PKC) or asymmetric encryption. The goal of PKC is to easily transition from a first state (e.g., a private key) to a second state (e.g., a public key) while reversing the transition from the second state to the first state nearly impossible, and in the process, proving possession of a secret key without exposing that secret key. The product is subsequently a one-way mathematical function, which makes it ideal for validating the authenticity of transactions such as cryptocurrency transactions because possession of the first state such as the secret key cannot be forged. PKC relies on a two-key model, the public and private key. The general purpose of PKC is to enable secure, private communication using digital signatures in a public channel that is susceptible to potentially malicious eavesdroppers.

FIG. 3 is an example flow diagram for providing providence certification, according to some implementations. As described in more detail below, a system generates providence certificates up the supply chain and generates a final providence certificate at the end of the supply chain.

In various implementations, a method begins at block 302, where a system such as system 202 of FIG. 2 generates one or more first stage or upstream providence certificates. In various implementations, the first stage providence certificates are associated with sources of the components of product 116. Also, the first stage source is associated with a first portion of a supply chain. The term first stage providence certificates may refer to providence certificates that the system generates in connection with sources in the upstream portion of a supply chain. As such, the terms first providence certificate, first stage providence certificate, and upstream providence certificate may be used interchangeably.

In various implementations, the first stage providence certificates are associated with components of a product. Also, each first stage providence certificate provides one or more predetermined assurances. In some implementations, such assurance may include a particular component (e.g., glass bottle, cork, etc.) meeting particular requirements or standards (e.g., being sustainable, organic, etc.). The particular assurances may vary and will depend on the particular implementation. In another example, the providence certificates may provide quality control and/or ecological certification of components of the product such as organic certification for a Champagne produce, sustainably harvested wood product certification, etc.

As described in more detail below, a second stage or final providence certificate is associated with the product. The final providence certificate also provides the assurances of the upstream providence certificates, as well as a final providence certificate for the end product for the end user. In various implementations, a providence certificate is a statement of assurance or attestation that a particular set of properties or conditions have been fulfilled. In various implementations, the providence certificate is digitally signed by an authority, which may be the producer of the good, or a trusted third party.

In some implementations, a providence certificate may be a number attached to the data being digitally signed. In an example implementation, a providence certificate may show the data with an actual digital signature component that abstracted away from the text, “This certificate is valid.” In various implementations, the emoji ID functions as the digital signature.

In various implementations, an emoji ID includes a sequence of emojis. Emojis may be utilized to provide a user with an easy and intuitive way to identify a person or entity such as a company. Emoji's are miniature pictures that can be used to express thoughts, ideas, and concepts, that can be entered using a keyboard or software application, and can be entered without using alpha-numeric characters. As described in detail below, Emojis are often easier to remember for a typical internet user than an alpha-numeric address. As such, a sequence of emojis rather than an alpha-numeric sequence may be better suited to ensuring that user or customer can successfully access information pertaining to a company.

In various implementations, the term “emoji sequence” may be used as an example of a type of ID that can be easy to remember and user-friendly. In some implementations, other sequences of characters that may include a mixture of emoji and non-emoji characters, as well as sequences that do not include emojis can also fall within the scope of the disclosure. As indicated herein, the use emoji sequences may be a more intuitive and user-friendly way of accessing information pertaining to a particular company, without having to remember a myriad of different addresses or identifiers that may rely on less intuitive alpha-numeric sequences.

With regard to providence certificates, in various implementations, the validation process or technique may vary, depending on the particular implementation. For example, the system may utilize an elliptic curve digital signature algorithm (ECDSA), Schnorr signatures, etc.

In various implementations, providence certificates may include the following example information:

This bottle was made using ethically sourced glass from

[symbol]

The cork in this bottle is organic, sourced from

[symbol]

Champagne bottled and produced by

[symbol]

In various implementations, a quick response (QE) code or other suitable type of matrix barcode when scanned produces the same text including the assurance statements and emoji IDs, and a “valid/not valid” decision.

As indicated above, various aspects of the system may be instantiated as a blockchain network. For example, in various implementations, the public key associated with the signing key is also associated with the emoji ID. As such, the association of the public key and the emoji ID is publicly available, and may be publicly available via a blockchain.

In some implementations, a given source may provide components having different assurances or attestations (e.g., different levels of sustainability, different levels of quality, different features, etc.). For instance, some users may have particular severe food allergies (e.g., peanut allergies, etc.). In some implementations, the system may know of such assurances for some components. As such the providence certificate would provide such assurances (e.g., whether particular ingredients are present or not, kosher, etc.).

In an example use case, a known, trusted owner of an emoji ID wants to provide a certificate of providence for each bottle of Champagne that they ship. Final source 106 may represent the Champagne seller and owner of the emoji ID. In this example, the source is a well known producer of Champagne in Champagne, France, and wants to protect its reputation as well as convey trustworthiness of its products to the market, including end users.

In an example implementation, the emoji ID, which may also be referred to as a yat, may be a string of emojis (e.g., Champagne bottle emoji, Champagne glasses emoji, Champagne bottle emoji, or [symbol] ). The same wine estate or Champagne producer wishes to show that they use bottles that come from a manufacturer that uses ethically sourced glass. The Champagne producer also wishes to show that they use organic corks.

Referring to the upstream portion of the supply chain shown in FIG. 1, source 102 may represent the glass producer. In this example, the glass producer has a reputation for ethically sourced glass and owns an emoji ID or yat (e.g., beach with umbrella emoji, beach with umbrella emoji, pointing finger emoji, glass emoji, or [symbol] ). In various implementations, source 102 sends to final source 106 a digitally signed providence certificate. The providence certificate includes a digitally signed message stating that the bottles for the Champagne were ethically sourced.

In this example scenario, the cork producer has a reputation for being an organic cork producer. The cork producer also owns an emoji ID or yat (e.g., green tree emoji, pointing finger emoji, Champagne bottle emoji, or [symbol] ).

In various implementations, the first stage providence certificates are each digitally signed with a private encryption key. In various implementations, providence certificates utilize data encryption techniques to keep information data safe. For example, the digital signature (which represents particular assurances of product quality, safety, etc.) cannot be altered unnoticed. As such, computer systems can easily verify providence certificates and associated assurances, further ensuring the trustworthiness of the product. This applies to first stage providence certificates and second stage providence certificates described herein.

In various implementations, emoji ID may function as a public key, which client users use to ensure that the attestation was indeed signed by them. For example, a glass producer would provide the digital signature to a champagne producer. The champagne producer cannot fake this digital signature. As such, one would be able to detect if the champagne producer lied and printed “This bottle is made from ethically sourced glass from or [symbol] . This because the glass producer would not have provided a signature in this case, and the champagne manufacturer cannot produce such a signature that is signed by the public key attached to or [symbol] .

In various implementations, each providence certificate is associated with an emoji identifier, which includes a string of emojis as shown in the examples herein. Providence certificates provide an emoji ID, which in turn provides a visible indication of trustworthiness that participants in the supply chain and the end user will notice. This applies to first stage providence certificates and second stage providence certificates described herein.

At block 304, the system generates one or more second stage or final providence certificates. In various implementations, the second stage providence certificates are associated with a final source of the product. In various implementations, the final source is associated with a final portion of the supply chain. In various implementations, the product passes from the final source to an end user in the second portion of the supply chain. The term second stage providence certificates may refer to providence certificates that the system generates in connection with a final source or sources in the downstream portion and/or of a supply chain. As such, the terms second providence certificate, second stage providence certificate, upstream providence certificate, and final providence certificate may be used interchangeably.

In various implementations, a first stage predetermined assurance includes an assurance that the product is made with materials that meet one or more predetermined requirements. As indicated above, final source 106 sources their glass bottles and corks from sources 102 and 104, both of which own respective emoji IDs. In various implementations, final source 106 provides a providence certificate with a digital signature signing a message directed to the final or complete product. For example, such a message may read, “Beach with umbrella emoji, beach with umbrella emoji, pointing finger emoji, glass emoji, or [symbol] ), sourced the glass bottle, and green tree emoji, pointing finger emoji, Champagne bottle emoji, or [symbol] sourced the cork for the Limited Release Grand Cru 2021 [timestamp].”

In various implementations, any second stage providence certificates or final providence certificate are each digitally signed with a private encryption key, where the second stage or final providence certificates are associated with the product. In various implementations, the first stage providence certificates and the second stage providence certificates are associated with emoji representations such as those described above, and the emoji representations are associated with emoji identifiers (IDs). For example,

In various implementations, the second stage or final providence certificates provide the first stage providence certificates and provides one or more final predetermined assurances with regard to the product.

In various implementations, the second stage predetermined assurance includes a final assurance that the product complies with the first stage predetermined assurances and includes the second portion of the supply chain. In some implementations, final source 106 may also include and/or combine messages from upstream sources and digitally signs the final providence certificate. Final source 106 may optionally provide their own custom message, as indicated above. In some implementations, Final source 106 may include their emoji ID and/or on the label. In some implementations, the system may include particular industry standard certifications, such as California Certified Organic (CCOF), for example, and including them as assurances in a providence certificates.

Consumers may then verify the signature chain by scanning a code on the label of the Champagne bottle. Such a code may be any suitable code such as a quick response (QR) code or other type of matrix barcode or two-dimensional barcode. In various implementations, as indicated above, a QR code may be scanned to access a given emoji ID. For example, the system may enable a user to scan the QR code with a smart phone or other device, where the providence certificate is displayed in response to the scanning of the QR code. The providence certificate includes a plain text message of assurance(s) plus the emoji ID or digital signature. In various implementations, the system may check digital signatures or emoji IDs against digital signatures of a database such as database 206 of FIG. 2, for example. A match indicates legitamate digital signatures.

In this example scenario, there is a very high degree of confidence that final source 106 (Champagne producer) is providing genuine providence certificates about their supply chain inputs (e.g., product components sourced from sources 102 and 104). This is because final source cannot fake those providence certificates without compromising the security of their suppliers. It would also be unlikely that final source 106 will collude with upstream sources to produce false providance certificates without compromising their reputations.

Implementations described herein rely on the reputation of the parties involved. If a scandal emerges about a given supplier using pesticides, for example, final source 106 cannot change the providence certificate on their label after the fact. Similarly, if a given supplier/source colludes with the final source to provide fake providence certificates (e.g., with knowledge of non-organic corks being used), the supplier using fake providence certificates places themselves at great reputational risk. As such, fake providence certificates are unlikely, as the reputation of the supplier and final source/champagne producer would be destroyed if publically exposed.

In another example use case, a given final source may want to certify a limited edition 5,000 release of Champagne with a number nnnn/5000. In this scenario, there might not be any upstream sources. As such, the owner digitally signs a message stating, “Limited Release Grand Cru 2021, 52/5,000 [timestamp].” The owner signs with the private key associated with the emoji ID (e.g., Champagne bottle emoji, Champagne glasses emoji, Champagne bottle emoji, or [symbol] ). The signature may be printed as a QR code on the label along with the message in plain text (for users to verify).

In various implementations, scanning the QR code checks the signature against a database associated with the system, and the digital signature is verified as “Yes, the message ‘Limited Release Grand Cm 2021, 52/5,000 [timestamp]’ was signed by emoji ID Champagne bottle emoji, Champagne glasses emoji, Champagne bottle emoji, or [symbol] . Otherwise, if the digital signature is not verified, the system may state, “No, this is an invalid signature (and probably a fake),” for example.

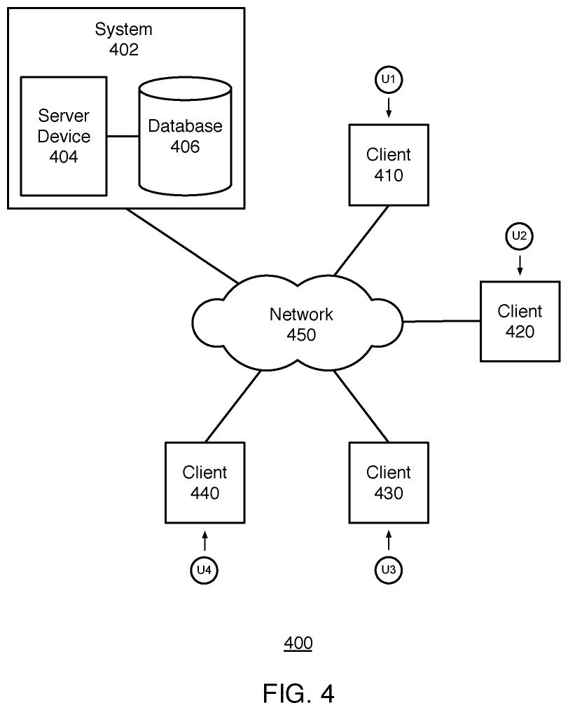

FIG. 4 is a block diagram of an example network environment 400, which may be used for some implementations described herein. In some implementations, network environment 400 includes a system 402, which includes a server device 404 and a database 406. For example, system 402 may be used to implement system 202 of FIG. 2, as well as to perform implementations described herein. Network environment 400 also includes client devices 410, 420, 430, and 440, which may communicate with system 402 and/or may communicate with each other directly or via system 402. Network environment 400 also includes a network 450 through which system 402 and client devices 410, 420, 430, and 440 communicate. Network 450 may be any suitable communication network such as a Wi-Fi network, Bluetooth network, the Internet, etc.

For ease of illustration, FIG. 4 shows one block for each of system 402, server device 404, and network database 406, and shows four blocks for client devices 410, 420, 430, and 440. Blocks 402, 404, and 406 may represent multiple systems, server devices, and network databases. Also, there may be any number of client devices. In other implementations, environment 400 may not have all of the components shown and/or may have other elements including other types of elements instead of, or in addition to, those shown herein.

While server 404 of system 402 performs implementations described herein, in other implementations, any suitable component or combination of components associated with server 402 or any suitable processor or processors associated with server 402 may facilitate performing the implementations described herein.

In the various implementations described herein, a processor of system 402 and/or a processor of any client device 410, 420, 430, and 440 cause the elements described herein (e.g., information, etc.) to be displayed in a user interface on one or more display screens.

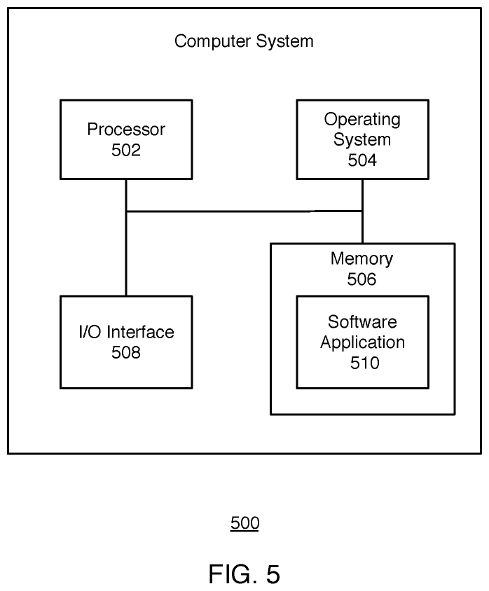

FIG. 5 is a block diagram of an example computer system 500, which may be used for implementations described herein. For example, computer system 500 may be used to implement server device 404 of FIG. 4 and/or system 202 of FIG. 2, as well as to perform implementations described herein. Computer system 500 is operationally coupled to one or more processing units such as processor 502, a memory 504, and a bus 506 that couples to various system components, including processor 502 and memory 504. Bus 506 represents one or more of any of several types of bus structures, including a memory bus, a memory controller, a peripheral bus, an accelerated graphics port, a processor or local bus using any of a variety of bus architectures, etc. Memory 504 may include computer readable media in the form of volatile memory, such as a random access memory (RAM) 508, a cache memory 510, and a storage unit 512, which may include non-volatile storage media or other types of memory. Memory 504 may include at least one program product having a set of at least one program code module such as program code 514 that are configured to carry out the functions of implementations described herein when executed by processor 502. Computer system 500 may also communicate with a display 516 or one or more other external devices 518 via input/output (I/O) interface(s) 520. Computer system 500 may also communicate with one or more networks via network adapter 522. In other implementations, computer system 500 may not have all of the components shown and/or may have other elements including other types of elements instead of, or in addition to, those shown herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various implementations of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system comprising:
one or more processors; and
logic encoded in one or more non-transitory computer-readable storage media for execution by the one or more processors and when executed operable to cause the one or more processors to perform operations comprising:
generating a first providence certificate digitally signed with a first private encryption key, wherein the first providence certificate is associated with a first component of a product, and wherein the first providence certificate provides a first predetermined assurance; and
generating a second providence certificate digitally signed with a second private encryption key, wherein the second providence certificate is associated with the product, and wherein the second providence certificate provides the first providence certificate and a second predetermined assurance.

2. The system of claim 1, wherein the first providence certificate and the second providence certificate are associated with emoji representations, and wherein the emoji representations are associated with emoji identifiers (IDs).

3. The system of claim 1, wherein the first providence certificate is associated with a first source of the first component of the product, and where the first source is associated with a first portion of a supply chain.

4. The system of claim 1, wherein the second providence certificate is associated with a second source of the product, and wherein the second source is associated with a second portion of a supply chain.

5. The system of claim 1, wherein the second providence certificate is associated with a second source of the product, wherein the second source is associated with a second portion of a supply chain, and wherein the product passes from the second source to an end user in the second portion of the supply chain.

6. The system of claim 1, wherein the first predetermined assurance comprises an assurance that the product is made with materials that meet one or more predetermined requirements.

7. The system of claim 1, wherein the second predetermined assurance comprises a final assurance that the product complies with the first predetermined assurances.

8. A computer-implemented method for providing providence certification, the method comprising:
generating a first providence certificate digitally signed with a first private encryption key, wherein the first providence certificate is associated with a first component of a product, and wherein the first providence certificate provides a first predetermined assurance; and
generating a second providence certificate digitally signed with a second private encryption key, wherein the second providence certificate is associated with the product, and wherein the second providence certificate provides the first providence certificate and a second predetermined assurance.

9. The method of claim 8, wherein the first providence certificate and the second providence certificate are associated with emoji representations, and wherein the emoji representations are associated with emoji identifiers (IDs).

10. The method of claim 8, wherein the first providence certificate is associated with a first source of the first component of the product, and where the first source is associated with a first portion of a supply chain.

11. The method of claim 8, wherein the second providence certificate is associated with a second source of the product, and wherein the second source is associated with a second portion of a supply chain.

12. The method of claim 8, wherein the second providence certificate is associated with a second source of the product, wherein the second source is associated with a second portion of a supply chain, and wherein the product passes from the second source to an end user in the second portion of the supply chain.

13. The method of claim 8, wherein the first predetermined assurance comprises an assurance that the product is made with materials that meet one or more predetermined requirements.

14. The method of claim 8, wherein the second predetermined assurance comprises a final assurance that the product complies with the first predetermined assurances.

15. A non-transitory computer-readable storage medium with program instructions stored thereon, the program instructions when executed by one or more processors are operable to cause the one or more processors to perform operations comprising:
generating a first providence certificate digitally signed with a first private encryption key, wherein the first providence certificate is associated with a first component of a product, and wherein the first providence certificate provides a first predetermined assurance; and
generating a second providence certificate digitally signed with a second private encryption key, wherein the second providence certificate is associated with the product, and wherein the second providence certificate provides the first providence certificate and a second predetermined assurance.

16. The computer-readable storage medium of claim 15, wherein the first providence certificate and the second providence certificate are associated with emoji representations, and wherein the emoji representations are associated with emoji identifiers (IDs).

17. The computer-readable storage medium of claim 15, wherein the first providence certificate is associated with a first source of the first component of the product, and where the first source is associated with a first portion of a supply chain.

18. The computer-readable storage medium of claim 15, wherein the second providence certificate is associated with a second source of the product, and wherein the second source is associated with a second portion of a supply chain.

19. The computer-readable storage medium of claim 15, wherein the second providence certificate is associated with a second source of the product, wherein the second source is associated with a second portion of a supply chain, and wherein the product passes from the second source to an end user in the second portion of the supply chain.

20. The computer-readable storage medium of claim 15, wherein the first predetermined assurance comprises an assurance that the product is made with materials that meet one or more predetermined requirements.
